(19) United States
(12) Patent Application Publication
(10) Pub. No.: US 2008/0261183 A1
(43) Pub. Date: Oct. 23, 2008

(54) Device for treating stuttering and method of using the same

(76) Inventor: Steven Donaldson, City of Portland, OR (US)

Correspondence Address: Timothy E Siegel Patent Law, PLLC, 601 108th Avenue, Suite 1900, Bellevue, WA, 98004, US

(21) Appl. No.: 12/148,866

(22) Filed: Apr. 23, 2008

Related U.S. Application Data
(60) Provisional application No. 60/926,055, filed on Apr. 23, 2007.

(51) Int. Cl. G09B 19/04

(52) U.S. Cl. 434/185

(57) ABSTRACT

A method of treating a person for stuttering that comprises providing sensory stimulation that alternates between the right and left side of person's body. In one preferred embodiment this stimulation is performed by applying a stream of sound pulses, alternating between the ears, by an auditory stimulation device. Such a device would include a sound signal production unit and a pair of auditory ear-pieces designed so as to not entirely occlude the ear canals.

### CROSS-REFERENCE TO RELATED APPLICATION

This application claims the benefit of Provisional Application No. 60/926,055, filed Apr. 23, 2007.

### BACKGROUND

Although many techniques for treating stuttering have been originated and tried, no technique has been found to be universally successful. Accordingly, there is still a need for stuttering treatments so that a greater array of treatment techniques can be made available to speech therapists.

In a separate field of psychotherapy, a technique known as eye movement desensitization and reprogramming has been originated in order to help patients overcome trauma. In this technique, the patient is asked to move his eyes back and forth sideways at a tempo of about one cycle per second.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In a first separate aspect the present invention may take the form of a method of treating a person for stuttering that comprises providing sensory stimulation that alternates between the right and left side of the person's body.

In a second separate aspect the present invention may take the form of an auditory stimulation device, comprising a pair of auditory ear-pieces and a sound signal production unit that is adapted to cause the auditory ear-pieces to produce a stream of pulses of sound, alternating between the pair of auditory ear-pieces.

In a third separate aspect the present invention may take the form of an auditory stimulation device, comprising a sound signal production unit and a pair of auditory ear-pieces designed so as to not entirely occlude the ear canals.

In addition to the exemplary aspects and embodiments described above, further aspects and embodiments will become apparent by reference to the drawings and by study of the following detailed descriptions.

### BRIEF DESCRIPTION OF THE DRAWINGS

FIG. 1 is a perspective view of a user wearing an auditory stimulation device according to the present invention.

FIG. 2 is a detail view of an ear piece of the auditory stimulation device of FIG. 1, being worn in a human ear.

FIG. 3 is a block diagram showing the inner structure of the device of the device of FIG. 1.

FIG. 4 is a graphical representation of a wavetable.

Exemplary embodiments are illustrated in referenced figures of the drawings. It is intended that the embodiments and figures disclosed herein are to be considered illustrative rather than restrictive.

### DETAILED DESCRIPTION OF THE PREFERRED EMBODIMENT

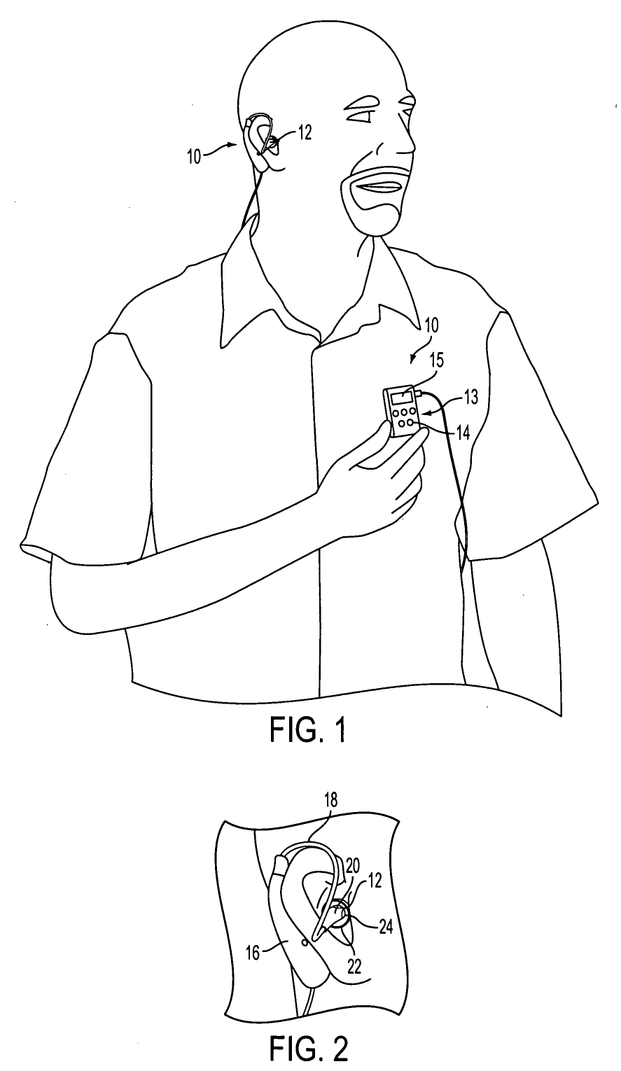

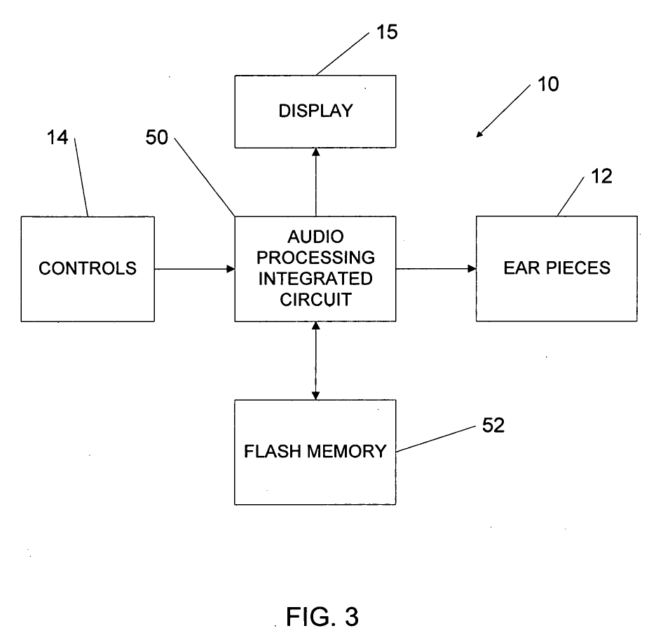

Referring to FIG. 1 in a preferred embodiment an assembly 10 is used that includes a pair of non-occluding ear pieces 12 (described in greater detail below), one for each ear. Ear pieces 12 are used to stimulate the ears with sound pulses that alternate between the two ears. Assembly 10 includes a control and display unit 13, including controls 14 that permit the user to set parameters and a display 15 that permits a user to check these settings. The parameters that may be set include a pulse repetition frequency that may be adjusted over a range of 0.1 cycles per second to 10 cycles per second, with the most likely range being between 0.5 cycles per second and two cycles per second. The tone may be set between 500 Hz and 10,000 Hz depending on the patient. The loudness, again according to what is found to be most effective for a particular patient, may be set between 20 dB and a 100 dB. Duty factor may be set in a range from 0.02 to 0.6. All of these ranges are merely exemplary, and skilled persons will recognize that other ranges are possible and could be advantageous. In a preferred embodiment, as further noted below, the type of sound produced by assembly 10 can be user-controlled.

Control unit 13 commands a behind-the-ear sound production unit 16, creates sound that is sent through a tube 18, to a sound port 20 that is held in place in the outer ear canal by a resilient curved web 22. A series of apertures 24 are defined between port 20 and web 22, to permit the entry of sound from outside the ear, as it is essential that the wearer be able to hear as he is wearing the device. Because it is a stuttering treatment device, assembly 10 will generally be most useful during conversation, in which the user must listen as well as speak. Moreover, during any speech it is very helpful for the speaker to be able to hear himself. In a preferred embodiment, ear piece 12 is the light pink or flesh color generally associated with hearing aids and other assistance devices, so that onlookers will not be mislead into thinking that the user is listening to some form of auditory entertainment.

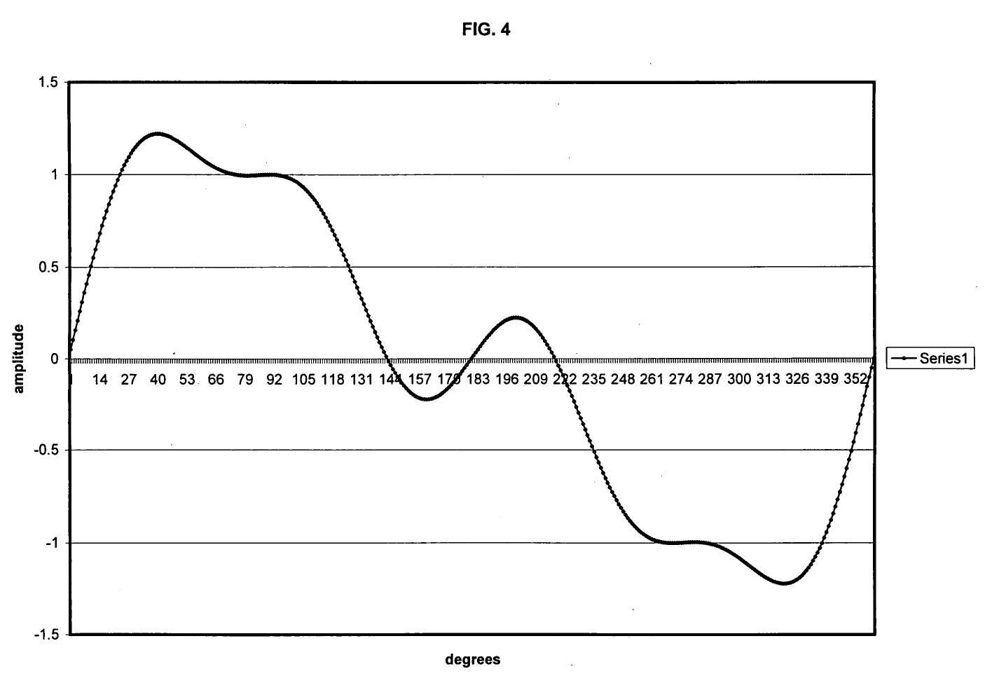

Referring to FIG. 2, from a functional perspective the assembly 10 includes a sound processing integrated circuit (“chip”) 50, such as a SigmaTel STMP 3500, which is available over the Internet at www.sigmatel.com. The sound processing chip 50 is capable of constructing an electrical signal that can stimulate a speaker to produce a sound wave, through the use of wavetable synthesis. A wavetable is a set of samples taken at a fairly short interval, for example one degree, over a single cycle of a sound wave that it is desired to reproduce. An example of a wavetable, presented in graphical form, is shown in FIG. 4. The sound chip 50 has a port for accepting input from a flash memory 52, where both computer instructions and a set of wavetables are stored. The IC 52 performs a digital-to-analog (D/A) conversion on the stream of wavetable data points that it receives, generating an electrical signal capable of driving a speaker (typically after some amplification). The rate at which the wavetable data points are fed to the (D/A) conversion is set by the sound chip 50 in response to user input, to create a desired pitch. In a preferred embodiment many waveforms are stored in the set of wavetable, so that the user can pick between, for example, oboe sound, trumpet sound, drum sound or clarinet sound. In general, although a sine wave or square wave would be functional, a sine wave or square wave sound tends to be somewhat harsh.

The control of the pulse repetition frequency (PRF) may be performed by establishing a counter that increments as a function of the clock rate and comparing the counter results with a variable that is set by means of the user controls. When the counter equals the variable value a new pulse is started, and a second counter begins to increment, this time to be compared to a second variable that sets the pulse width, also set by user input. By similar means of comparison the pulse is ended when the counter value equals that of the variable.

In a preferred embodiment, an adjustment session is held in which various pulse repetition frequencies, tones and loudness levels are tried. The patient may be asked to repeat a sentence while a particular combination of pulse repetition frequency tone and loudness levels are tried. Several different combinations may be attempted with the equipment being set to the most effective. Alternatively the patient may be given a system and invited to try various settings during the course of the day to determine which is most effective.

In an alternative preferred embodiment, the assembly includes a separate device for each ear, with the two devices being maintained in mutual synchronization. At least three different preferred embodiments address this requirement. In one preferred embodiment the two devices are occasionally placed in communication with each other, by, for example, a first device being equipped with an infrared (IR) transmitter and the other device being equipped with an IR receiver. The user periodically places the two devices so that the IR transmitter is able to send a signal to the IR receive. In one variant a button is pushed to cause the IR transmitter to begin transmitting. The IR transmitter then transmits a timing sequence, which the IR receiver receives and sends to a synchronization unit that understands the received signal and sets the relative time of the second device accordingly.

In another preferred embodiments the two devices are linked electrically by a plug and the synchronization information is passed electrically. In yet another embodiment, one of the devices includes a microphone, which is able to receive the sound signals from the first device, and can synchronize itself accordingly.

In another preferred embodiment alternating stimulation is applied to the eyes. This may be accomplished by way of special glasses having an LED mounted in each corner, where the arms meet the center portion of the frame. In yet another alternative preferred embodiment alternating side tactile stimulation is provided either by means of a special belt fitted about the abdomen or a special shirt.

In another alternative, auditory stimulation is applied to the skull, in places where it is known that sound waves travel easily to the ear and are heard. This technique has the advantage that the ears are left entirely un-occluded leaving the ears free for unimpeded hearing. Also, observers may not see any indication of an auditory device, and therefore will not call upon the user to explain the presence of the device. Also, if observers do not see the device there is no chance that they will conclude that the user is wearing an auditory device, such as an MPEG player, and will not draw any consequential negative inference.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A method of treating a person for stuttering that comprises providing sensory stimulation that alternates between the right and left side of said person's body.

2. The method of claim 1, wherein said sensory stimulation is auditory stimulation, applied to the ears.

3. The method of claim 2, wherein said auditory stimulation is made up of pulses of sound having a pulse repetition frequency, for each ear, of between 30 pulses per minute and 300 pulses per minute.

4. The method of claim 3, where said auditory stimulation is made up of pulses of sound having a pulse repetition frequency, for each ear, of between 100 pulses per minute and 240 pulses per minute.

5. The method of claim 2, wherein said auditory stimulation is of sound having a frequency of between 300 Hz and 10,000 Hz.

6. The method of claim 2, wherein said auditory stimulation has a loudness of between 10 dB and 70 dB.

7. The method of claim 1, further including a fitting session in which stimulation parameters are determined.

8. An auditory stimulation device, comprising:
a. a pair of auditory ear-pieces;
b. a sound signal production unit that is adapted to cause said auditory ear-pieces to produce a stream of pulses of sound, alternating between said pair of auditory ear-pieces.

9. The auditory stimulation device of claim 8, wherein said sound signal production unit includes controls for setting the volume of said stream of pulses of sound.

10. The auditory stimulation device of claim 8, wherein said sound signal production unit includes controls for setting the tone of said stream of pulses of sound.

11. The auditory stimulation device of claim 8, wherein said sound signal production unit includes controls for setting the sound waveform of said stream of pulses of sound.

12. The auditory stimulation device of claim 8, wherein said controls can lock said pulse repetition frequency, so that it can only be changed by someone having knowledge of how to override said lock.

13. An auditory stimulation device, comprising:
a. a sound signal production unit; and
b. a pair of auditory ear-pieces designed so as to not entirely occlude the ear canals.

14. The auditory stimulation device of claim 13, wherein said sound signal production unit is adapted to cause said auditory ear-pieces to produce a stream of pulses of sound, alternating between said pair of auditory ear-pieces.
